(19) United States
(12) Patent Application Publication
(10) Pub. No.: US 2003/0048883 A1
(43) Pub. Date: Mar. 13, 2003

(54) Integrated pstn-ip answering service

(76) Inventors: Anthony H Warren, Ipswich (GB); Andrew J Heron, Lowestoft (GB)

Correspondence Address: Nixon & Vanderhye, 8th Floor, 1100 North Glebe Road, Arlington, VA, 22201-4714, US

(21) Appl. No.: 10/239,711

(22) PCT Filed: Mar. 16, 2001
(86) PCT No.: PCT/GB01/01168

(30) Foreign Application Priority Data
Mar. 31, 2000 (EP) 00302749.7

(51) Int. Cl. H04M 1/64; H04J 3/16

(52) U.S. Cl. 379/88.17; 370/466

(57) ABSTRACT

An answering system for use to provide a mass answering capability in a communications network is based on a platform architecture which terminates switched telephony calls from the PSTN on a platform that is based entirely on an Internet Protocol (IP) network using Voice over IP (VoIP) technologies to deliver streamed media to the PSTN caller. Also, media is streamed to callers accessing the platform via the Internet using a web browser or H.323 compliant client. By using an IP based internal architecture, the platform provides integral support for access via the Internet for both service users, i.e. end callers and service/platform maintainers. This integrated approach leads to a single management facility to manage both the switched voice telephony and the Internet elements of the service delivered by the platform.

### FIELD OF THE INVENTION

This invention relates to the field of answering systems for use with communications networks, in particular to automated mass answering systems.

### BACKGROUND

Mass answering systems are used in telecommunications networks whenever there is a need to economically answer a large volume of calls in a short period of time. A typical use of such a system is in connection with televoting systems, which allow callers to register a vote in respect of some advertised entity. For example, in the case of the ITV ‘Stars in Their Eyes’ programme, callers vote for the amateur performer they perceive to have best emulated a well-known celebrity performer. The televoting service provides a list of telephone numbers, one for each performer. Callers dial a particular telephone number to vote for a particular performer and each call is acknowledged with a short voice announcement.

British Telecommunications public limited company provides a televoting service via an equipment platform known as the Recorded Information Distribution Equipment (RIDE) platform. The existing platform is a switched telephony product that uses 2Mb/s circuits to distribute announcements to digital main switching units (DMSU) so that calls are routed to the nearest DMSU for connection to an appropriate announcement.

Although televoting via the public switched telephone network (PSTN) is a well-established product, the increasing penetration of Internet access has provided opportunities for a new range of services accessible via the Internet rather than the PSTN. In the case of televoting, as well as voting via the telephone, Internet users are able to register votes via a web page.

Taking the example of the ‘Stars in Their Eyes’ programme, a web page is advertised at the same time as the telephone numbers. Callers then access the web page via their usual Internet service provider account and register a vote for one of the performers listed on the web page.

However, the current scheme for providing PSTN and Internet access is that two entirely separate services operate in parallel, without any integration between them for either service creation and deployment or service monitoring by the service provider. As a consequence, substantial effort is required on the part of a service provider not only to set up both the PSTN and Internet components of a televoting campaign separately, but also to ensure that the results generated by each of the separate components will mesh together correctly.

### SUMMARY OF THE INVENTION

According to the present invention, there is provided an answering system for use in a communications network to provide an answering capability for calls originating from different sources, comprising means for processing calls originating from a telephone network operating according to a first communications protocol and calls originating from a data communications network operating according to a second communications protocol different from the first protocol, wherein the processing means is configured to process calls according to a common protocol irrespective of the origin of the call.

The answering system is capable of automatically answering and processing calls from different sources.

The processing means can include data communications network service means for servicing a call originating from the data communications network, for example the Internet.

The processing means can also include telephone network service means for servicing a call originating from the telephone network. The telephone network service means can include a PSTN/IP gateway for converting calls conforming to the first protocol to calls conforming to the common protocol.

The system can further comprise a media server for streaming media to a caller in response to a call originating from the telephone network, or from the data communications network.

The system can also include management means provided in common for the data communications network service means and the telephone network service means. The management means may be operable to configure services to be provided by both the data communications network service means and the telephone network service means. Advantageously, the data communications network service means, the telephone network service means and the management means can be supported on a common communications platform which is configured to operate according to the common protocol.

By providing a single managed platform, services can be easily provided so as to be accessible over various different communications systems, for example the PSTN and the Internet. The integrated approach also provides the service provider with a single view of the service, irrespective of the access method.

Access to the platform can be provided via the Internet, which is suited to supporting caller access by emerging terminal types such as H.323 clients.

According to the present invention, there is further provided a method of answering calls originating from different sources in a communications network, comprising receiving a first call originating from a telephone network operating according to a first communications protocol, receiving a second call originating from a data communications network operating according to a second communications protocol different from the first protocol, and processing the first and second calls according to a common protocol irrespective of the origin of the call.

According to the present invention, there is also provided computer software to be run on a hardware platform to implement data transfer which conforms to a network protocol, for answering calls originating from different sources in a communications network, comprising a software module for receiving a first call originating from a telephone network operating according to a first communications protocol, a software module for receiving a second call originating from a data communications network operating according to a second communications protocol different from the first protocol, and a software module configured to process the first and second calls according to the network protocol irrespective of the origin of the call.

The platform architecture according to one aspect of the present invention terminates switched telephony calls from the PSTN on a platform that is based entirely on an Internet Protocol (IP) network using Voice over IP (VoIP) technologies to deliver streamed media to the PSTN caller. Also, media is streamed to callers accessing the platform via the Internet using a web browser or H.323 compliant client. By using an IP based internal architecture, the platform provides integral support for access via the Internet for both service users, i.e. end callers and service/platform providers. This integrated approach leads to a common means of processing events regardless of their origin and a means of integrating voice and Internet call events into a single automated answering/processing platform. Internet call events can be, for example, Web page interactions, IP telephony calls and e-mails. It further leads to a single management facility to manage both the switched voice telephony and the Internet elements of the service delivered by the platform.

A system according to the invention can therefore facilitate an economical mass answering solution, which can include the provision of a single call count, which accounts for all calls regardless of access method.

### BRIEF DESCRIPTION OF THE DRAWINGS

Embodiments of the invention will now be described by way of example with references to the accompanying drawings, in which:

FIG. 1 is a schematic diagram showing the high level logical architecture of a mass answering system;

FIG. 2 is a schematic diagram showing a more detailed design of the mass answering system shown in FIG. 1;

FIG. 3 is a flow chart illustrating the overall organisation and execution of a televoting campaign to be run on the mass answering system shown in FIGS. 1 and 2;

FIG. 4 is a flow chart illustrating the setting up of a campaign by a service provider; and

FIG. 5 is a flow chart illustrating the operation of the mass answering system shown in FIGS. 1 and 2.

### DETAILED DESCRIPTION

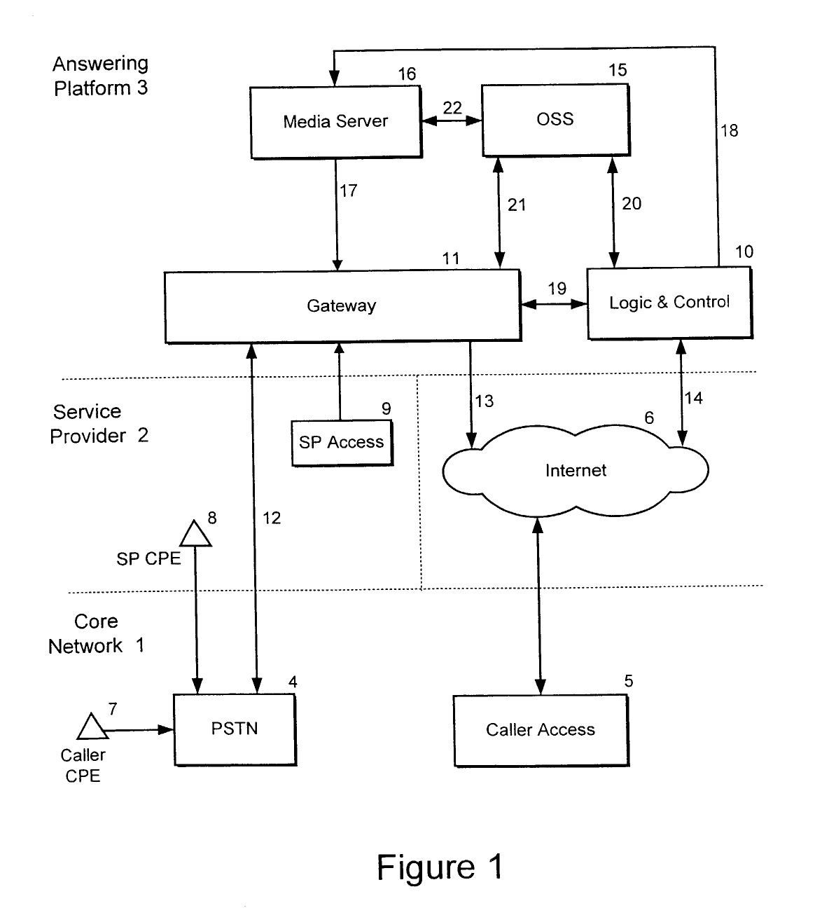

Referring to FIG. 1, the logical architecture of a mass answering system is shown in three parts: a core network domain 1, a service provider domain 2 and an answering platform 3. The core network domain 1 contains the call transport, switching and routing systems responsible for delivering calls into the answering platform 3. The service provider domain 2 contains systems to provide service provider access into the answering platform 3. The answering platform 3 contains the systems required to deploy, deliver and maintain an integrated answering service over both the public switched telephone network (PSTN) and the Internet.

Considering each part of the architecture in more detail, the core network domain 1 includes the PSTN 4 and a Caller Access system 5 which provides Internet based access mechanisms to the Internet 6, for example a dial up connection via an Internet service provider using a web browser. The PSTN 4 contains the core transport network at both local and trunk level, providing a telephone service to both caller customer premises equipment (CPE) 7 and to the service provider customer premises equipment (SP CPE) 8.

The service provider domain 2 includes a service provider (SP) Access System 9 which illustrates service provider access into the answering platform 3. However, this is a thin client environment where the functionality to enable the service provider to configure resources to deliver a customised answering service is contained within a Logic and Control system 10, described below, which is accessible by the service provider through, for example, a web browser over the Internet 6.

Within the answering platform 3, a Gateway 11 provides an interface to both the PSTN 4 and the Internet 6. The connection 12 between the PSTN 4 and the Gateway 11 carries telephony calls over, for example, analogue PSTN or ISDN links, while controlled outbound access to the Internet 6 is provided over a connection 13 between the Gateway 11 and the Internet 6. The Logic and Control system 10 delivers the application logic and switching control within the answering platform 3 which is required to deploy, deliver and maintain the service to the PSTN 4 and the Internet 6. It is accessed via an interface 14 from the Internet 6.

An Operational Support System (OSS) 15 contains the functionality required for the platform provider, for example a telecommunications company, to manage the platform for both deployment and operational support of components and services. It also contains the functionality required for service providers to configure services from the resources supplied to them by the platform provider, as well as providing an interface between the answering platform 3 and the platform provider's operational support systems external to the platform (not shown).

A Media Server 16 contains components to deliver audio and/or video content into a call. The connection of incoming calls to the Media Server 16 is controlled by the Logic and Control system 10, whilst the delivery of media can be under the autonomous control of the Media Server 16 or externally controlled by the Logic and Control system 10.

The information carried by the interfaces between the various system elements specified above will now be described in more detail.

An interface 17 between the Media Server 16 and the Gateway 11 carries media streams of Voice over Internet Protocol (VoIP) calls which conform to the H.323 standard over a local area network (LAN), destined for the end caller 7 on the PSTN 4 via the Gateway 11. The H.323 standard is a recommendation of the International Telecommunications Union (ITU) which sets standards for multimedia communications across IP-based networks, including the Internet.

An interface 18 between the Logic & Control system 10 and the Media Server 16 carries H.323 VoIP call set-up and clear-down messages, including media control messages to specify which media should be delivered on connection of a call. An interface 19 between the Logic & Control system 10 and the Gateway 11 also carries H.323 set-up and clear-down messages. An interface 20 between the Logic & Control system 10 and the OSS 15 enables the OSS 15 to retrieve and update configuration data as well as platform logging data held in the Logic & Control system 10. An interface 21 between the Gateway 11 and the OSS 15 carries configuration information to update the Gateway 11 and operational data used to monitor the operational status and performance of the Gateway 11. Finally, an interface 22 between the OSS 15 and the Media Server 16 carries configuration information to update the Media Server 16, in particular the media content to be streamed to a caller, together with operational data used to monitor the operational status and performance of the Media Server 16.

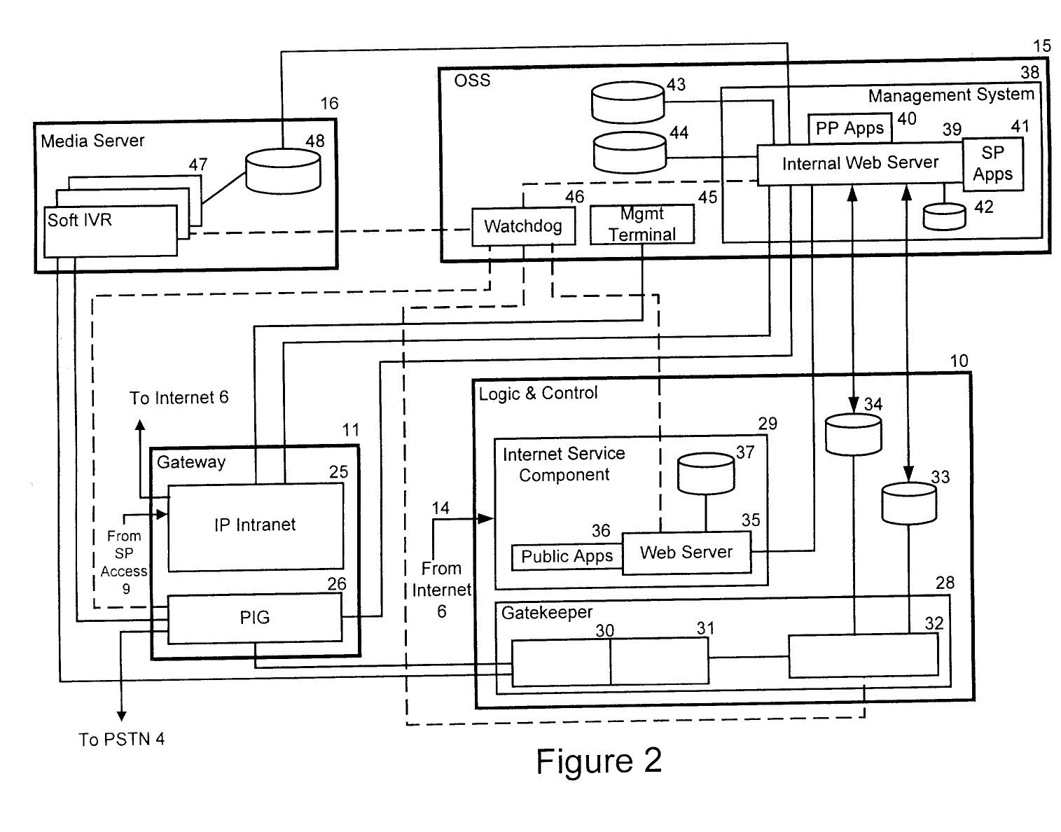

The components of the answering platform 3 are shown in more detail in FIG. 2.

Referring to FIG. 2, the Gateway 11 comprises an Internet Protocol (IP) based Intranet 25, which is the intranet of the platform provider and includes, for example, a local area network (LAN) on which the answering platform is hosted. The Intranet 25 is accessible to authorised service providers from the Internet 6, via, for example, a conventional firewall (not shown).

A PSTN/IP Gateway (PIG) 26 provides a gateway function between the switched telephony environment of the PSTN and the IP environment of the answering platform 3. It terminates calls originating on the PSTN 4, codes the speech signal using appropriate voice standards supported by the H.323 standard, for example G.711 and G.723, and packetizes it for transmission over the IP network to a destination end point. Additionally, the PIG 26 terminates the PSTN signalling, such as ISDN or C7, and converts it into H.323 signalling for negotiating call set-up in the H.323 IP environment.

The Logic and Control system 10 comprises a Gatekeeper 28 and an Internet Service Component 29. The Gatekeeper 28 is responsible for H.323 collaboration with the Gateway 11 and Media Server 16 systems, both of which are H.323 end points, for set-up of calls, via the Q.931 protocol which is part of the H.323 standard, and for call monitoring of calls in progress. The Gatekeeper 28 comprises an H.323 stack 30 and a Gatekeeper Application 31 The Gatekeeper Application 31 is responsible for negotiating call set up between H.323 end points using the H.323 protocol via the H.323 stack 30. The Gatekeeper Application 31 also provides an Application Program Interface (API) to support a Service Execution Application 32, which is an application that delivers supplementary call control intelligence into the Gatekeeper system, in addition to simple call set-up. For example, it provides translation of dialled numbers, also referred to herein as Called Party Numbers (CPN), to a destination IP address and service number. The destination IP address is for example the address of the Media Server 16 and the service number identifies the media content which is to be supplied in response to the dialled number. The Service Execution Application 32 reads number translations previously set up by the Service Provider from a text file 33 to provide appropriate routing and writes H.323 call records to a logging text file 34.

The Internet Service Component 29 provides a public facing web server capability for applications that are accessible to the end caller. It includes a Web Server 35 which provides an application execution environment for Public Applications 36 which, for example, deliver a public Internet voting capability. The Public Applications component 36 presents an Internet caller with a web page listing the vote choices. Making a choice causes the vote to be recorded in a Web Records file 37 and an acknowledgement page to be displayed to the caller.

The OSS 15 includes a Management System 38 which contains the components required by both the platform provider and the service provider to maintain both the platform and the services delivered by it. The Management System 38 includes an Internal Web Server 39 which provides an application execution environment for Platform Provider Applications (PP Apps) 40 and Service Provider Applications (SP Apps) 41. Platform Provider Applications 40 are a suite of applications accessible only to authorised platform provider personnel for deploying and managing service providers, platform resources and platform components. The Service Provider Applications 41 present a service provider with web pages that allow the service provider to configure the service being provided, for example a voting service, and to view call statistics. This includes the facility to upload announcement files. The OSS 15 also includes databases 42, 43, 44 for use by the platform provider and the service.

The OSS 15 further includes a Management Terminal 45 which, in keeping with the three-tier logical architecture described so far, provides thin client access into the platform for access to the Platform Provider Applications 40 delivered by the Internal Web Server 39. The OSS 15 also includes a Watchdog 46, which is a suite of applications collectively charged with monitoring the operating status and performance of various components of the platform. The platform provider is notified of error conditions through audible and visual alarms.

The Media Server 16 comprises a series of IVR (integrated voice response) applications 47, referred to herein as SoftIVR, which are responsible for delivering various types of media, for example ranging from a simple voice announcement through to complex interactive services, to the calling customer at an H.323 end point, or appearing to be an H.323 end point by virtue of their connection into the platform via the PIG 26. The Media Server 16 appears as an H.323 end point, auto answers an offered call and, on successful set up of the call to the originating end point, for example the PIG 26, streams media to the PIG 26 for eventual delivery to the end-caller on the PSTN. The media streamed is selected according to the translated Called Party Number and service number sent in the call setup message. Media content is stored in an Announcement Library Database 48.

The Media Server 16 is also capable of streaming media to Internet callers accessing the answering platform via the Internet using H.323 compliant clients, rather than through the PIG 26.

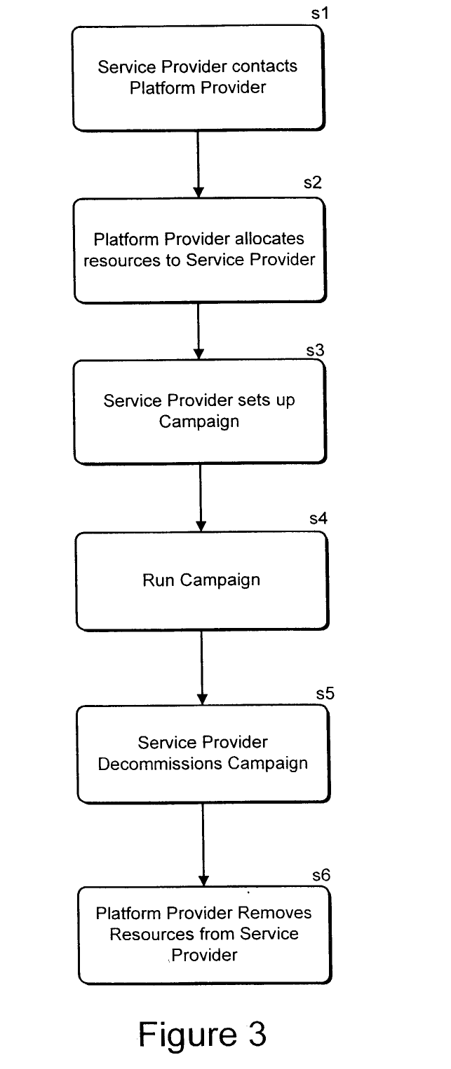

An example of the operation of the system described above in relation to FIGS. 1 and 2 will now be described, with reference to FIG. 3, using the example of a televoting campaign. Prior to the requirement for a televoting service, for example when a television talent competition is to be run, the service provider, i.e. the organisation requiring the use of a mass answering system, contacts the platform provider (step s1). The platform provider then carries out a number of activities to provide the service provider with the resources necessary to run the campaign (step s2). These activities include:

Entering data relating to the service provider.

Allocating a set of telephone numbers to the service provider, for example premium rate 0906 numbers, and applying default routing to the allocated number range to ensure that calls made to the numbers prior to the service provider's campaign being active are properly terminated. For example, such calls can be connected to a standard announcement that the number is not in use.

Associating default announcements with the allocated numbers for the pre-campaign, post campaign and campaign-active conditions.

Allocating an area on the file system of the public facing Web Server 35 and installing default web page content in the allocated web space.

Creating accounts to grant access to the platform to the service provider.

Granting the service provider access to the platform provider's Intranet 25, including allocating a username and password.

Following allocation of resources, the service provider sets up its campaign corresponding to its own requirements (step s3), by completing the following activities:

Creating a new campaign with a unique identity.

Defining a date and time for the start and finish of the campaign.

Assigning a group of numbers already assigned from the platform provider to the campaign. This may be all the numbers assigned to the service provider or a subset, allowing the remainder to be used by another campaign.

Associating a custom recorded announcement audio file with each number assigned to the campaign.

Uploading customised web page content to the allocated web server page.

The campaign is then run by the service provider (step s4), as described in more detail below.

Following the end of the campaign, the service provider removes the associations between the defined campaign and the set of allocated numbers (step s5). The platform provider then terminates the service provider access to the system (step s6), which can include the following steps:

Reclaiming the numbers associated with the service provider.

Making the reclaimed numbers unobtainable, which will negate any routing or announcement associated with the numbers.

Deleting the content of the web space.

Suspending accounts on all components.

Reclaiming access to the platform provider's Intranet.

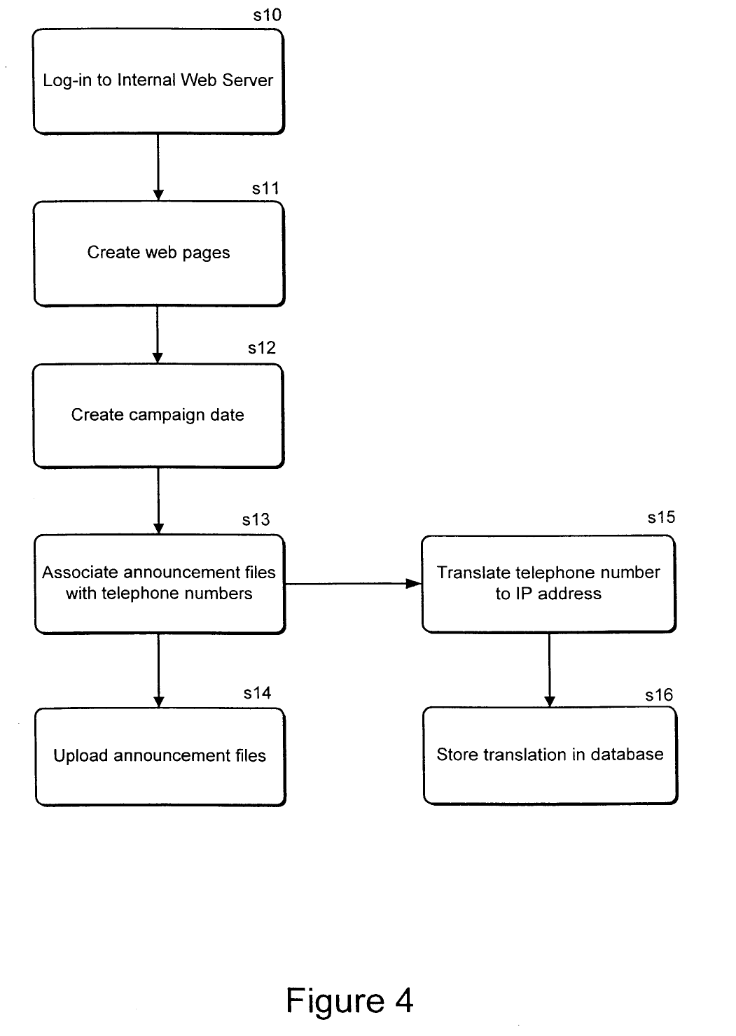

Referring to FIG. 4, the activities set out above in relation to setting up the campaign (step s3) are carried out by the service provider through the Internal Web Server 39, by logging in via the Internet 6 (step s10). For example, when the performers in a television talent competition have finished their performances, a telephone number, for example an 0906 number, is displayed for each performer. Typically, the numbers for each performer are identical aside from the final one or two digits, which are 01 for the first performer, 02 for the second, 10 for the tenth performer and so on. At the same time, a web address is given for Internet users to vote. The service provider uses the SP Applications component 41 to create the necessary web pages to present the performers (step s11). The service provider also creates campaign data (step s12) which is stored in a campaign data database 44, which can subsequently be queried and updated, for example using the Microsoft Open Database Connectivity (MS ODBC) API. The campaign data can include the campaign name, start and end date and times and other characteristics, for example whether the campaign includes an Internet voting element. The service provider associates each telephone number to be dialled with an announcement (step s13) and uploads announcement files corresponding to the telephone numbers to the announcement database 48 at the Media Server 16 (step s14).

At the same time, the Internal Web Server 39 translates (step s15) each telephone number and corresponding announcement to the IP address of the Media Server 16 and a service number, which specifies the relevant SoftIVR application 47 at the Media Server 16 to be used to provide a response to the number dialled by the caller. For example, a selected IP address and service number direct a SoftIVR application 47 to provide a message from the announcement database 48 thanking the caller for calling and confirming that their vote has been registered for the name of the performer corresponding to the number called. The translation data is stored in a text file 33 (step s16) for subsequent retrieval by the Service Execution Application 32.

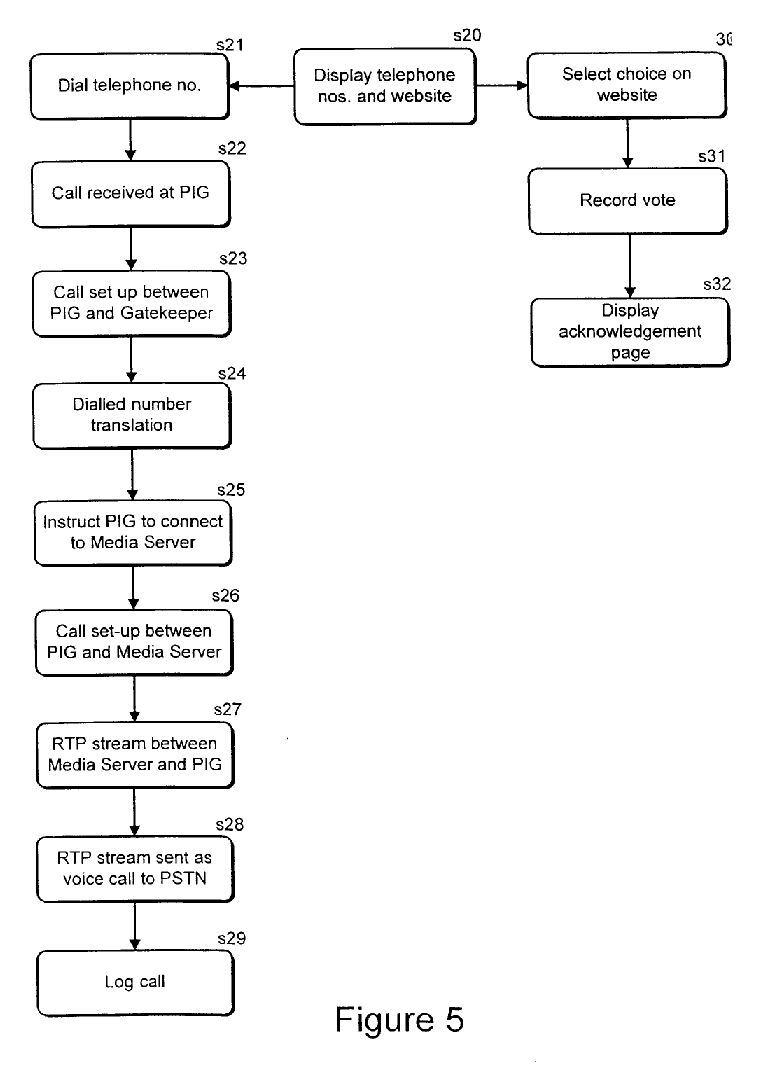

FIG. 5 illustrates the operation of the mass answering system referred to above as the “Run Campaign” step (step s4), using the illustration of one viewer voting by telephone and one voting over the Internet, each representative of a large number of viewers using these respective methods.

Following the completion of the talent competition part of the television show, the telephone number corresponding to each performer is displayed, as is the website address for Internet voters (step s20). The telephone voter calls the number associated with the performer he wishes to vote for (step s21). The Internet voter logs in to the displayed website through their usual Internet access mechanism, and selects the performer he wishes to vote for, for example by clicking on the performer's name on the screen (step s30).

Dealing with the telephone voter first, his or her call is received at the PIG 26 within the Gateway 11 (step s22). The PIG 26 then collaborates with the Gatekeeper Application 31 via the H.323 stack 30 to set up an H.323 call to the Media Server 16 (steps s23 to s26). H.323 call set-up first occurs between the PIG 26 and the Gatekeeper 28 (step s23). The Service Execution Application 32 provides number translation of the dialled number into a corresponding IP address and service number based on the data previously set up in the number translations database 33 by the service provider (step s24). The Gatekeeper Application 31 then instructs the PIG 26 to connect to the appropriate SoftIVR application 47 in the Media Server 16 in accordance with the translated IP address and service number (s25). Peer-to-peer call set-up then proceeds between the two end points (s26). On successful call set-up, the Media Server 16 sends a Real-Time Protocol (RTP) media stream of recorded audio to the H.323 connected PIG 26 (step s27), for delivery to the end-caller on the PSTN 4 (step s28). Each call is logged in the logging text file 34 (step s29).

The Internet Service Component 29 deals with voting via the web page. As described above, when an Internet caller accesses the web page supported by the Web Server 35, it displays a list of vote choices. Selecting a choice (step s30) causes the vote to be recorded in the Web Records file 37 (step s31) and an acknowledgement page to be displayed to the caller (step s32).

At the end of the voting procedure, the service provider can access the total number of votes for each performer by using the Internal Web Server 39. The Internal Web Server 39 has direct access to the call records from the H.323 call logging text file 34, and can request the HTTP call record logging text file 37 through the public facing Web Server 35.

While the invention has primarily been described in relation to a televoting system, it is applicable to any environment in which a capability to automatically answer calls made from different sources is required, in particular in connection with passive or interactive real-time voice services.

1. An answering system for use in a communications network to provide an answering capability for calls originating from different sources, comprising: means (3) for processing calls originating from a telephone network (4) operating according to a first communications protocol and calls originating from a data communications network (6) operating according to a second communications protocol different from the first protocol, wherein the processing means is configured to process calls according to a common protocol irrespective of the origin of the call.

2. A system according to claim 1, wherein the first protocol comprises a protocol operative on a public telecommunications network.

3. A system according to claim 1 or 2, wherein the second protocol comprises the Internet Protocol (IP).

4. A system according to any one of the preceding claims, wherein the common protocol comprises the Internet Protocol (IP).

5. A system according to any one of the preceding claims, wherein the processing means includes data communications network service means (35) for servicing a call originating from the data communications network (6).

6. A system according to claim 5, wherein the data communications network (6) comprises the Internet.

7. A system according to claim 6, wherein the data communications network service means comprises a web server (35).

8. A system according to any one of the preceding claims, wherein the processing means includes telephone network service means (26, 28, 16) for servicing a call originating from the telephone network (4).

9. A system according to claim 8, wherein the telephone network service means includes a PSTN/IP gateway (26) for converting calls conforming to the first protocol to calls conforming to the common protocol.

10. A system according to claim 8 or 9, further comprising a media server (16) for streaming media to a caller in response to a call originating from the telephone network (4).

11. A system according to claim 10, wherein the media server (16) is configured to stream media to a caller in response to a call originating from the data communications network (6).

12. A system according to any one of claims 5 to 11, further comprising management means (15) provided in common for the data communications network service means and the telephone network service means.

13. A system according to claim 12, wherein the management means is operable to configure services to be provided by both the data communications network service means and the telephone network service means.

14. A system according to claim 12 or 13, wherein the data communications network service means, the telephone network service means and the management means are supported on a common communications platform (25), which is configured to operate according to the common protocol.

15. A system according to any one of the preceding claims, further comprising means for logging calls made from each of said different sources.

16. A system according to any one of the preceding claims, configured to provide a televoting service.

17. A method of answering calls originating from different sources in a communications network, comprising:
receiving a first call originating from a telephone network (4) operating according to a first communications protocol;
receiving a second call originating from a data communications network (6) operating according to a second communications protocol different from the first protocol, and
processing the first and second calls according to a common protocol irrespective of the origin of the call.

18. A method according to claim 17, including the step of converting the first call from the first communications protocol to the common protocol.

19. A method according to claim 17 or 18, wherein the step of processing the first and second calls comprises providing answering services to callers originating the first and second calls.

20. A method according to claim 19, further comprising managing the answering services from a single platform irrespective of the origin of the call.

21. A program to be run on a computer to perform a method according to any one of claims 17 to 20.

22. Computer software to be run on a hardware platform to implement data transfer which conforms to a network protocol, for answering calls originating from different sources in a communications network, comprising:
a software module for receiving a first call originating from a telephone network (4) operating according to a first communications protocol;
a software module for receiving a second call originating from a data communications network (6) operating according to a second communications protocol different from the first protocol, and
a software module configured to process the first and second calls according to the network protocol irrespective of the origin of the call.
